(19) United States
(12) Patent Application Publication
(10) Pub. No.: US 2012/0044346 A1
(43) Pub. Date: Feb. 23, 2012

(54) APPARATUS AND METHOD FOR INSPECTING INTERNAL DEFECT OF SUBSTRATE

(76) Inventors: Yen-Chun CHOU, Taipei (TW); Cheng-Kai Chen, Taipei (TW); Jen-Ming Chang, Taipei (TW); Yu-Hsi Lee, Taipei (TW); Che-Min Lin, Taipei (TW)

(21) Appl. No.: 13/028,692

(22) Filed: Feb. 16, 2011

(30) Foreign Application Priority Data
Aug. 23, 2010 (TW) 099128148

(51) Int. Cl. H04N 9/04

(52) U.S. Cl. 348/131; 348/E09.002

(57) ABSTRACT

An apparatus inspects internal defects of substrate, the substrate having an upper surface and a plurality of side surfaces connected with the upper surface. The apparatus includes at least one light source arranged on one of the side surfaces of the substrate and emitting a light beam on the corresponding side surface and into the substrate, the incident angle of the light beam is limited to a first predetermined angle within a range allowing the light beam to transmit in a total internal reflection manner in the substrate; an image capturing module arranged above the substrate to capture the image of the upper surface of the substrate, a light shield mask arranged between the image capturing module and the substrate and shielding an edge portion of the upper surface of the substrate.

### BACKGROUND OF THE INVENTION

1. Field of the Invention

The present invention relates to an apparatus and method for inspecting internal defects of substrate.

2. Description of Related Art

Semiconductor processes includes thin film deposition and related steps, which can be used to provide electronic devices on substrates. In practice, internal defects such as opaque particles and bubbles in the substrates may cause a significant influence on the quality of the electronic devices on the substrates. In another aspect, transportations, thermal treatments or acid etching processes may cause cracks to form in the substrates.

For this reason, it is necessary to carry out a non-destructive inspection to find out if there is any defect in the substrate. The most frequently-used conventional inspection apparatus includes a light source and a camera respectively arranged at opposite sides of the substrate. The light source emits a light beam capable of penetrating the substrate. When the substrate is illuminated from below by the light source, the camera can capture the image of the substrate from above. Because light can be reflected, refracted or scattered when it encounters the internal defects in the substrate, the light transmittance at the internal defects is consequently lowered. So the images of the internal defects can be captured by the camera as corresponding darker points. And the positions and sizes of the darker points can further be measured by manual or computer image analysis techniques.

Since the results of the image analysis strongly depend on the clarity of the internal defect images, it becomes a major issue to obtain clear and accurate images of the internal defects in the inspection process as mentioned above. FIG. 1 shows a schematic view of the mentioned inspection process. In such an inspection process, not only the internal defects 12 can be captured by the camera as darker points in the images, but also external defects 11 like post-processing contaminant and the intrinsic roughness on the surfaces of the substrate 10 can be captured as darker points. However, since the mentioned image analysis techniques cannot effectively distinguish the internal defects 12 from those darker points, the external defects 11 could be identified as the internal defects 12.

In another aspect, as FIG. 2 shows, since a part of light can be diffracted when it encounters an obstacle, the images of the smaller defects will disappear when the intensity of the light is increased. That means the dimensions of the images of the internal defects are inversely proportional to the intensity of the light illuminated thereon. While inspecting thicker substrate, the intensity of light has to be increased to capture images with an acceptable brightness. However, if the light intensity should reach a certain value, the intensity of the diffracted light will be so high as to reduce the visibility of the defects. As a result, higher resolution camera is needed to capture the images of the defects and the manufacturing cost is consequently increased. Besides, the thickness variation within the substrate can affect the brightness uniformity of the images captured, which makes the light intensity hard to adjust to a value for optimized image. In another aspect, as FIG. 3 shows, when the smaller defects are illuminated by a non-parallel light beam, the dimensions of the smaller defects in the images will reduce. That means multi-directional light beam cannot be used to enhance the clarity of the smaller defects images. FIG. 4 shows an image picture including a crack captured by the conventional inspection apparatus.

### SUMMARY OF THE INVENTION

In order to overcome the above mentioned problem, the present invention is to provide a special designed method for illuminating substrate. The present invention transmits light in substrate in total internal reflection manner, which is able to effectively enhance the image quality of the internal defects like cracks, pin holes, impurities and bubbles. Besides, external defects will not form any image. The method of the present invention not only provides enhanced capability to detect the internal defects in the substrate, but also overcomes the problem that the interior of the substrate is not easy to be detected after the substrate has been applied surface treatments.

The objective of the present invention is to provide a method for inspecting internal defects of substrate, which is able to provide images of the internal defects with better image quality.

For achieving the above mentioned objective, the present invention provides a method for inspecting internal defects of substrate, the substrate having an upper surface and a plurality of side surfaces connected with the upper surface, the method including: providing a plurality of light sources on the side surfaces of the substrate, each of the light sources emitting a light beam on the corresponding side surface and into the substrate, the incident angle of the light beam is limited to a first predetermined angle within a range allowing the light beam to transmit in a total reflection manner in the substrate; and providing an image capturing module above the substrate to capture the image of the upper surface of the substrate, whereby the light sources can be driven one by one to emit light beams to the side surfaces, while one of the light sources emits a light beam to the corresponding side surface, the image capturing module captures the image of a half of the upper surface adjacent to the opposite side surface, and the captured images can be processed into a complete image of the upper surface.

Besides, the another objective of the present invention is to provide an apparatus for inspecting internal defects of substrate, which is able to provide images of the internal defects with better image quality.

The apparatus for inspecting internal defects of substrate, the substrate having an upper surface and a plurality of side surfaces connected with the upper surface, the apparatus including: at least one light source arranged on one of the side surfaces of the substrate, the light source emitting a light beam on the corresponding side surface and into the substrate, the incident angle of the light beam is limited to a first predetermined angle within a range allowing the light beam to transmit in a total reflection manner in the substrate; an image capturing module arranged above the substrate to capture the image of the upper surface of the substrate, a light shield mask arranged between the image capturing module and the substrate and shielding an edge portion of the upper surface of the substrate.

Besides, the present invention provides an apparatus for inspecting internal defects of substrate, the substrate having an upper surface and a plurality of side surfaces connected with the upper surface, the apparatus including: at least one light source arranged on one of the side surfaces of the substrate, the light source emitting a light beam on the corresponding side surface and into the substrate, the incident angle of the light beam is limited to a first predetermined angle within a range allowing the light beam to transmit in a total reflection manner in the substrate; an image capturing module arranged above the substrate to capture the image of a strip-shaped portion of the upper surface of the substrate; a light shield bar arranged between the light source and the substrate and correspondingly shielding an end of the strip-shaped portion; and a transferring module used for moving the substrate with respect to the image capturing module, whereby the strip-shaped portion can move along the upper surface and the image capturing module can capture the images of every parts of the upper surface.

The present invention transmits the light in substrate in total internal reflection manner to effectively enhance the image quality of the internal defects. When the light encounters the internal defects, it will be reflected, refracted or scattered and change its propagation direction and form light spots on the image captured by the image capturing module. The method can improve the image quality of the internal defects and thus increase the number of the internal defects inspected.

### BRIEF DESCRIPTION OF THE DRAWINGS

FIG. 1 is a schematic view of the conventional apparatus for inspecting defects in substrate;

FIG. 2 is a schematic view showing inspecting process of the conventional apparatus;

FIG. 3 is another schematic view showing inspecting process of the conventional apparatus;

FIG. 4 showing an image picture including a crack captured by the conventional inspection apparatus;

FIG. 5 is a schematic view of the apparatus for inspecting internal defects in substrate of the present invention;

FIG. 6 is another schematic view of the apparatus for inspecting internal defects in substrate of the present invention;

FIG. 7 shows the cracks image captured by the apparatus of the present invention;

FIG. 8 is another schematic view of the apparatus for inspecting internal defects in substrate of the present invention;

FIG. 9 shows a chart of light intensity to the pulse width of image signal and image contrast;

FIG. 10 is another schematic view of the apparatus for inspecting internal defects in substrate of the present invention;

FIG. 11 is another schematic view of the apparatus for inspecting internal defects in substrate of the present invention;

FIG. 12 shows the over brightness image of the edge portions of the substrate;

FIG. 13 is a schematic view including steps of the method for inspecting internal defects in substrate of the present invention;

FIG. 14 is another schematic view of the apparatus for inspecting internal defects in substrate of the present invention;

FIG. 15 shows the picture of substrate with cracks image;

FIG. 16 is another schematic view of the apparatus for inspecting internal defects in substrate of the present invention;

FIG. 17 is another side view of the apparatus for inspecting internal defects in substrate in FIG. 16; and

FIG. 18 shows the picture of the result of the apparatus for inspecting internal defects in substrate.

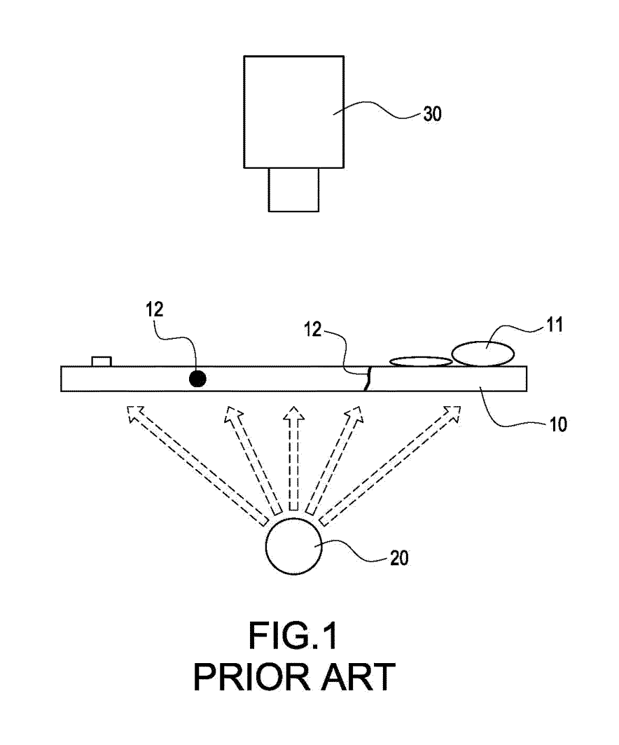

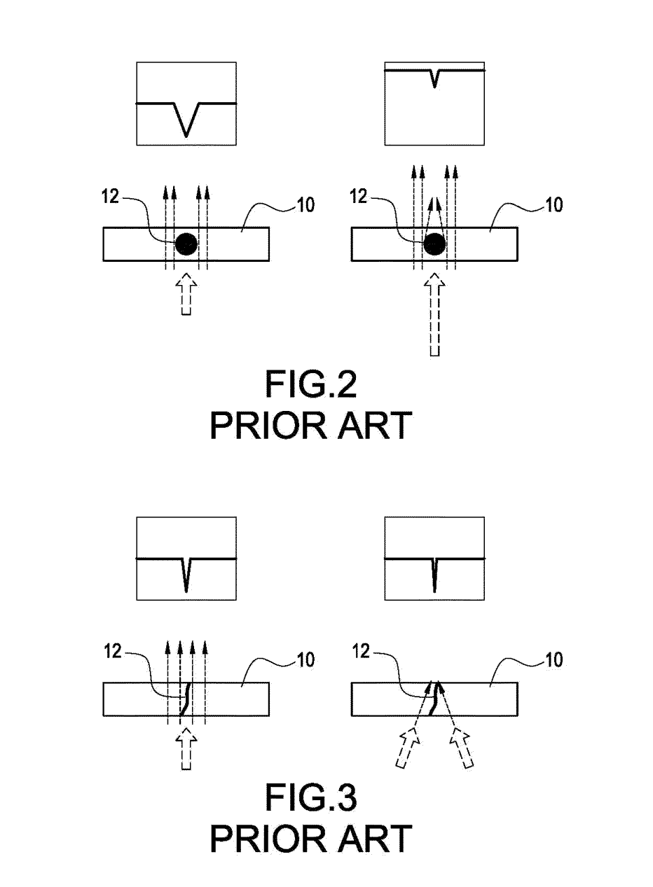

### DETAILED DESCRIPTION OF THE INVENTION

The present invention is described below in detailed with the reference to accompanying drawings.

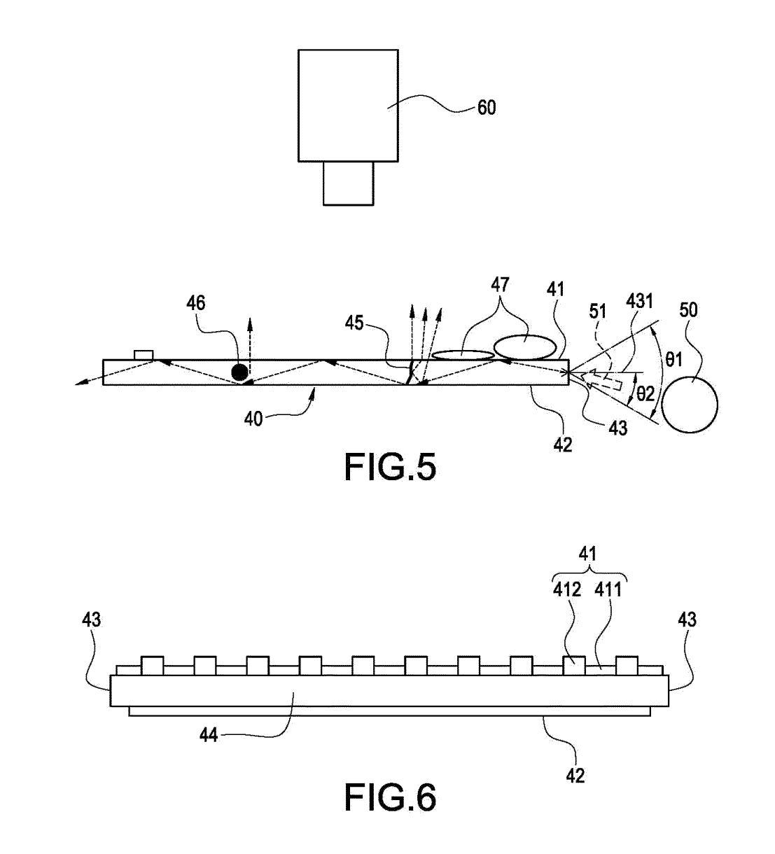

FIG. 5 shows a schematic view of the apparatus according to the embodiment of the present invention. The apparatus can be used for inspecting internal defects of a substrate 40. The apparatus mainly includes a light source 50 and an image capturing module 60.

The light source 50 is arranged on one of the side surface 43 of the substrate 40 and emits a light beam 51 on the corresponding side surface 43 and into the substrate 40. Preferably, the light beam 51 is a parallel light beam whose beam components propagate in the same directions. This can increase the amount of light penetrating into the substrate 40. In this embodiment, the substrate 40 is a silicon wafer, so the light source 50 is an infrared light source which can emit IR light beam to penetrate the silicon wafer. In alternative applications, the light source 50 is not limited to the above-mentioned infrared light source. If the substrate 40 is, for example, glass material, the light source 50 will be visible light source. Specifically, the light source 50 can be halogen light bulb with optical fiber tube and collimated lens, or can be light emitting diode array or laser diode array with collimated lens, which can provide parallel light beam.

Specifically, as FIG. 6 shows, the substrate 40 is, but not limited to, a solar cell substrate. The substrate 40 has a main plate 44, an upper surface 41 and a bottom surface 42, and a plurality of side surfaces 43 connecting the upper surface 41 and the bottom surface 42. The upper surface 41 includes a plurality of transparent anti-reflection portions 411 and a plurality of opaque metal electrode portions 412. The bottom surface 42 is an opaque metal conductor. The side surfaces 43 are substantially orthogonal to the upper surface 41 and the bottom surface 42.

It should be mentioned that in order to distinguish the internal defects from the external defects of the substrate, as FIG. 5 shows, the incident angle of the light beam 51 relative to the normal direction of the side surface 43 is limited to a first predetermined angle θ1 within a range allowing the light beam 51 to transmit in a total reflection manner in the substrate 40. The first predetermined angle θ1 can be calculated by the principle of total internal reflection based on the wavelength of the light beam 51 and the refractive index of the substrate 40.

In practical use, the thickness of the substrate 40 is often less than 1 mm and the alignment between the substrate 40 and the light source 50 cannot be precisely controlled. Besides, in order to ensure that at least some amount of light can be emitted into the substrate 40, the diameter of the light source 50 should be lager than the thickness of the substrate 40. But, some amount of light will illuminate the upper surface 41 and cause the image of the upper surface 41 to show some unwanted light area. In order to avoid such a situation, the incident angle of the light beam 51 relative to the normal direction of the side surface 43 can be further limited to a second predetermined angle θ2 which is a half part of the first predetermined angle θ1, away from the image capturing module 60. By limiting incident angle to the second predetermined angle θ2, the light beam 51 will no longer illuminate the upper surface 41 of the substrate 40.

The image capturing module 60 can be arranged above or below the substrate 40 to capture the image of the substrate 40. In this embodiment, the upper surface 41 includes the transparent anti-reflection portions 411 and the opaque metal electrode portions 412, and the bottom surface 42 is an opaque metal conductor. Therefore, the image capturing module 60 should be arranged above the substrate 40 to capture the light outputted from the anti-reflection portions 411 of the upper surface 41. The outputted light may be the reflected light, refracted light or scattered light by internal defects like the cracks 45 or opaque particles 46. The image capturing module 60 can be various kinds of image sensing devices like camera or video recorder.

When the light beam 51 is emitted on the side surface 43 at an incident angle within the second predetermined angle θ2, most of the light beam 51 will be able to enter the substrate 40 and transmit in the substrate 40. On the contrary, when the light beam 51 emitted on the side surface 43 is not at an incident angle within the second predetermined angle θ2, most of the light beam 51 will pass through the substrate 40 and form an unwanted light area where no defects can be inspected, and only a small amount of the light beam 51 can enter the substrate 40 and transmit in the substrate 40. Besides, when the incident angle of the light beam 51 is more far away from the second predetermined angle θ2, the amount of light entering the substrate 40 is less.

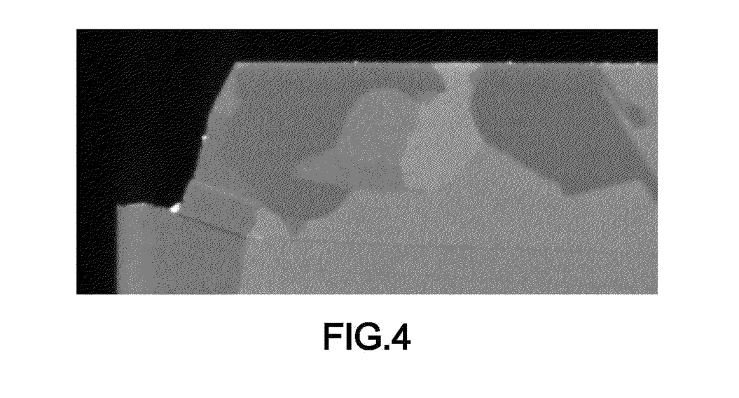

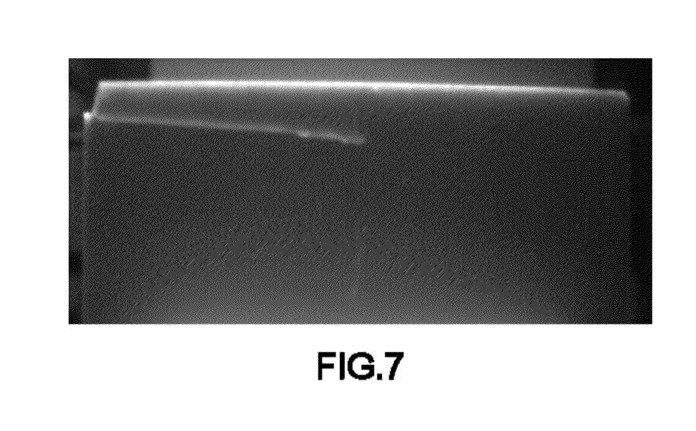

After entering the substrate 40, most of the light beam 51 can be allowed to transmit in a total internal reflection manner in the substrate 40. If there is no defect in the substrate 40, no light will output from the upper surface 41 of the substrate 40. The light beam 51 transmitting within the substrate 40 remains in the substrate 40 until it outputs from the opposite side surface 43 or its energy is depleted. If there are some defects in the substrate 40, the light beam 51 within the substrate 40 can be reflected, refracted or scattered by the internal defects like cracks 45, opaque particles 46 or bubbles, and outputs from the upper surface 41 of the substrate 40 to form light spots thereon. Thus, the light spots can be captured by the image capturing module 60 which is above the substrate 40. The picture in the FIG. 7 shows the cracks image captured by the apparatus of the present invention. Comparing to the picture in FIG. 4, the cracks image in FIG. 7 is apparently sharp and clear.

On the other hand, external defects like particles 47 on the upper surface 41 of the substrate 40 have no influence to the propagation of the light beam 51 in the substrate 40. The particles 47 may include dust, plastic micro-particles, oil containment, water marks or fingerprints. Because the light beam 51 in the substrate 40 will not pass through the particles 47, there is no light outputting from the particles 47 and then captured by the image capturing module 60. Therefore, the image of the internal defects can be distinguished from that of the external defects on the upper surface 41. Besides, the microstructure on the upper surface 41 caused by etching process will not be captured by the image capturing module 60, and will not form any light spot which may be treated as internal defects.

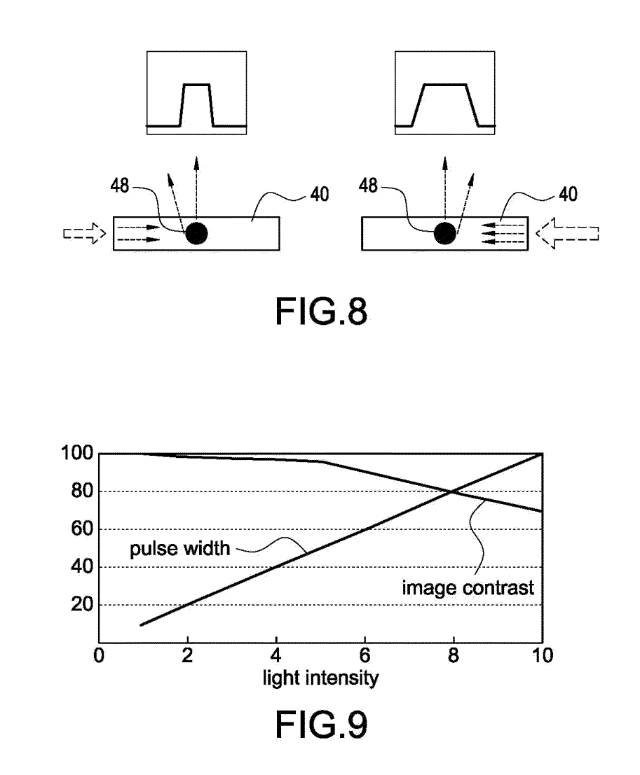

As FIG. 8 shows, since the light spot images formed by the internal defects is mainly caused from light scattering at the interfaces. The intensity of the light beam 51 can be increased to improve the clarity of the images. The left part of the FIG. 8 illustrates a condition of low light intensity and the right part illustrates another condition of high light intensity. When the light intensity is higher, the internal defects can generate an image signal with wider pulse width. That means the condition of high light intensity can be used to improve the image quality of even smaller internal defects. FIG. 9 shows a chart of light intensity to the pulse width of image signal and image contrast. As can be seen in the chart, when the light intensity is increased, the pulse width of defects will be wider and the image contrast does not drop too much, which indeed improves the image quality.

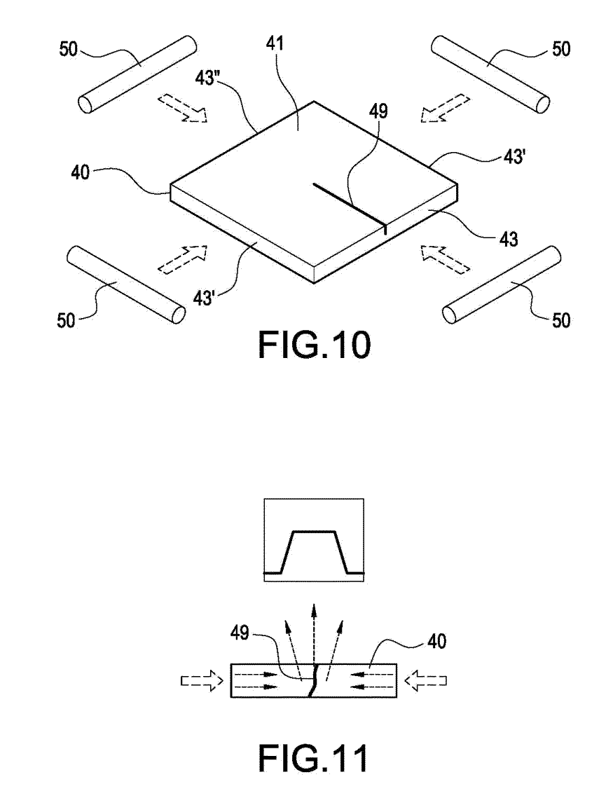

FIG. 10 shows another embodiment of the present invention. A plurality of light sources 50 can be arranged on the side surfaces 43, 43′ and 43″. Each of the light sources 50 can emit a light beam capable of penetrating the substrate 40 to improve the image quality of the internal defects 49 in the substrate 40. The light sources 50 are linear light source and each are parallel to the longitudinal direction of the corresponding side surface 43, 43′ or 43″ of the substrate 40. As can be seen in FIG. 10, the extension direction of the internal defect 49 is substantially perpendicular to the side surface 43. The contribution to the image quality from the light entered from the side surface 43 is much less than the contribution to the image quality from the light entered from the other side surface 43′. As FIG. 11 shows, when the internal defect 49 is illuminated by several light beams from different directions, the light component perpendicular to the internal defect 49 can effectively improve the image quality of the internal defect 49.

By illuminating from different side surfaces 43, 43′ and 43″, the image quality of the internal defects can be improved. Even smaller defects can be inspected by the apparatus of the invention. Besides, since smaller defects can be inspected, the maximum resolution required for the image capturing module 60 can be decreased, and the cost thereof can be decreased. Furthermore, the maximum resolution will not be limited by the image apparatus which can be provided in the current market.

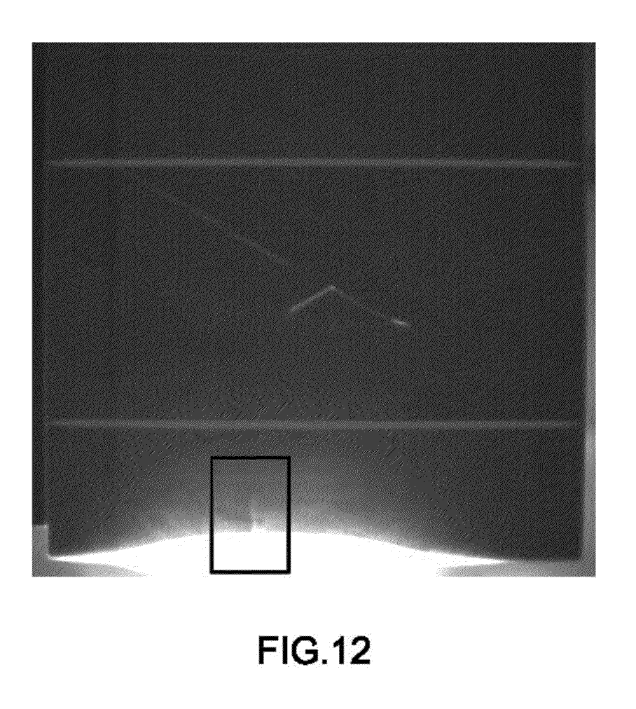

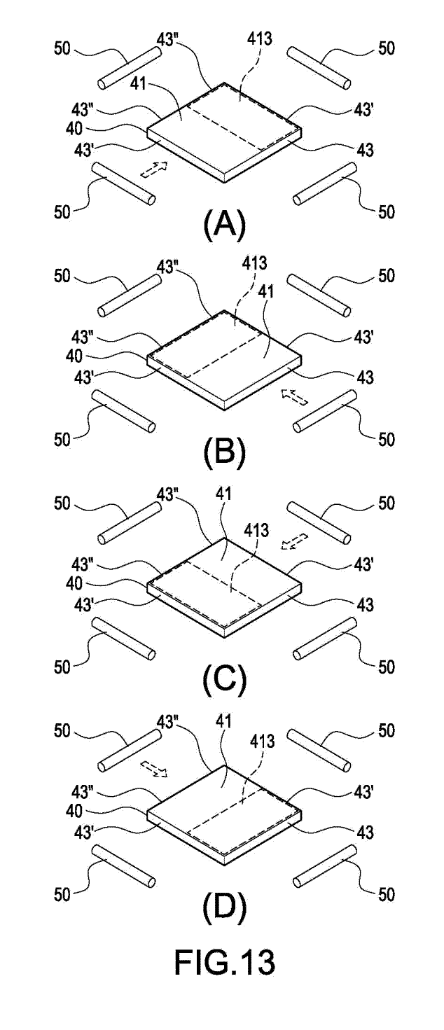

Besides, in practical application, it is not easy to limit the entire light beam emitted to the side surface to be within the second predetermined angle θ2, therefore, at least a part of light may escape from the edge portions of the substrate 40 which are very close to the light sources 50. Then, as FIG. 12 shows, it will be too bright to inspect any internal defect within the images of this edge portions. In order to overcome this issue and improve the quality of the image captured by the image capturing module 60, as FIG. 13 shows, a cyclic illumination method is introduced to illuminate the substrate 40.

A plurality of light sources 50 are respectively arranged at the side surfaces 43 of the substrate 40. Each of the light sources 50 can emit a light beam on the corresponding side surface 43 and into the substrate 40. The image capturing module 60 can be used to capture the image of the upper surface 41 of the substrate 40. While operating, as FIG. 13 A, B, C and D show, the light sources 50 can be driven one by one to emit light beams to the side surfaces 43. While one of the light sources 50 emits a light beam to the corresponding side surface 43, the image capturing module 60 can capture the image of a half part 413 of the upper surface 41 adjacent to the opposite side surface 43. Because the half part 413 is away from the light source 50, it will not be too bright to inspect the internal defects within the images of the half part 413. After capturing all the half parts 413, the captured images can be processed into a complete image of the upper surface 41. Thus, the problem of over brightness can be solved, and the complete image of the upper surface 41 can obtain.

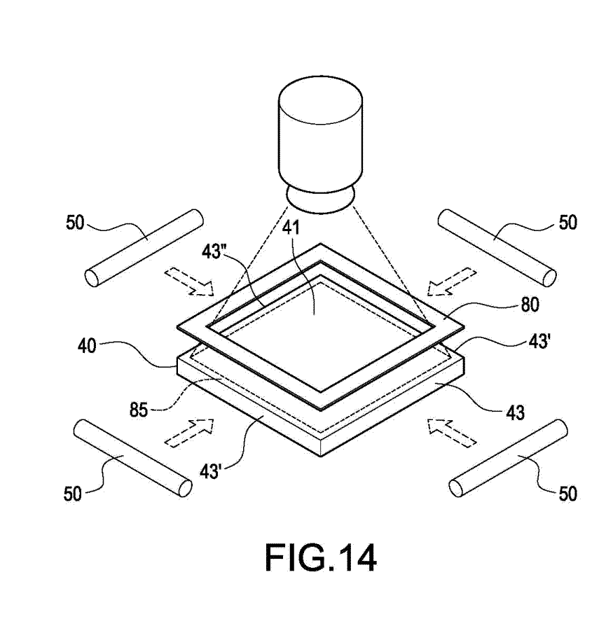

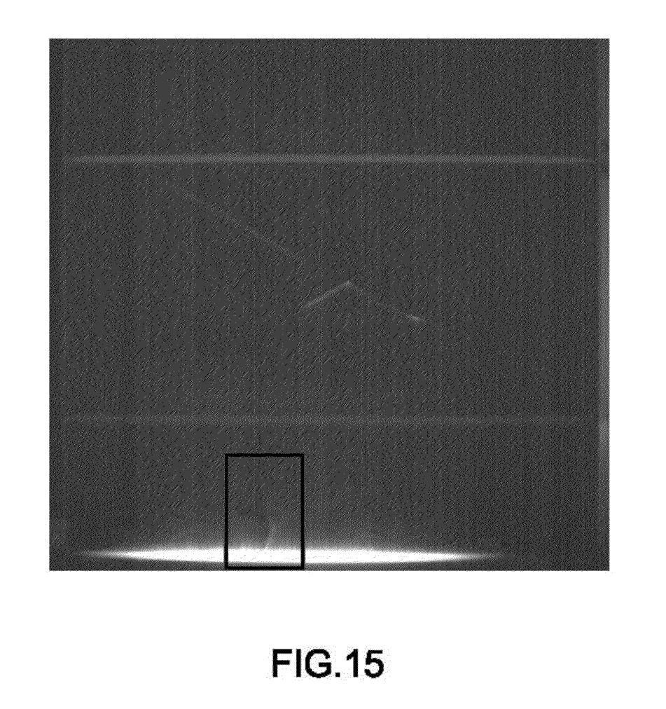

In another aspect, the present invention provides another way to overcome the mentioned over-brightness problem. As FIG. 14 shows, a light shield mask 80 is arranged between the image capturing module 60 and the substrate 40 or even adjacent to the image capturing module 60 or the substrate 40. The light shield mask 80 is used for shielding the edge portion of the upper surface 41 of the substrate 40. By shielding the edge portion of the upper surface 41, the mentioned over brightness problem can also be overcome. In this embodiment, the light shield mask 80 is of ring shape and covers all the edge portions of the upper surface 41 of the substrate 40. In practical application, the light shield mask 80 can be used to cover only one side of the edge portions of the upper surface 41. Besides, the number of the light sources 50 can be at least one and is not limited to four as shown in FIG. 14. The number of the light shield mask 80 can be one or more than one. FIG. 15 shows the picture of substrate 40 with cracks image.

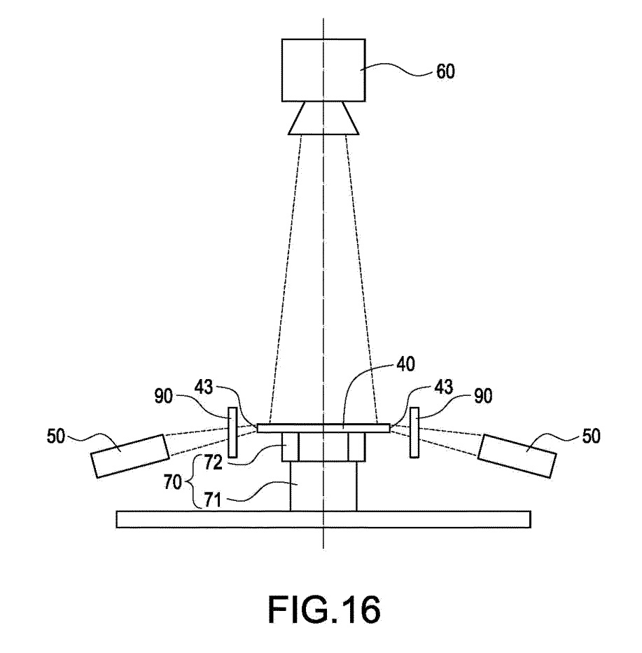

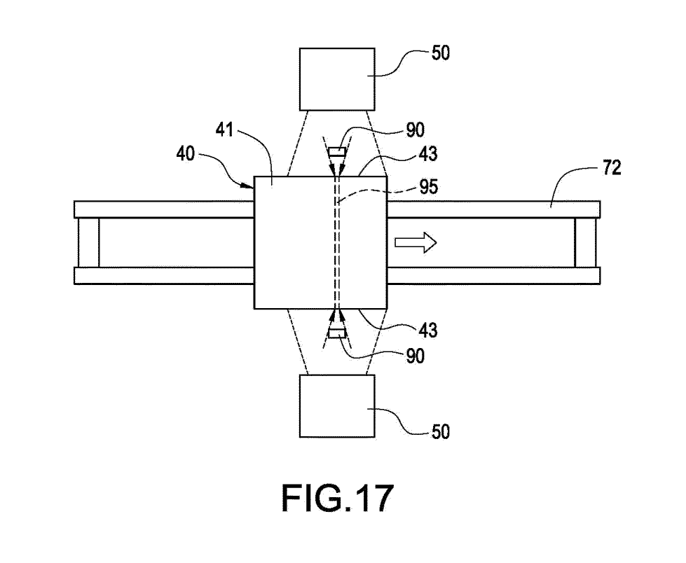

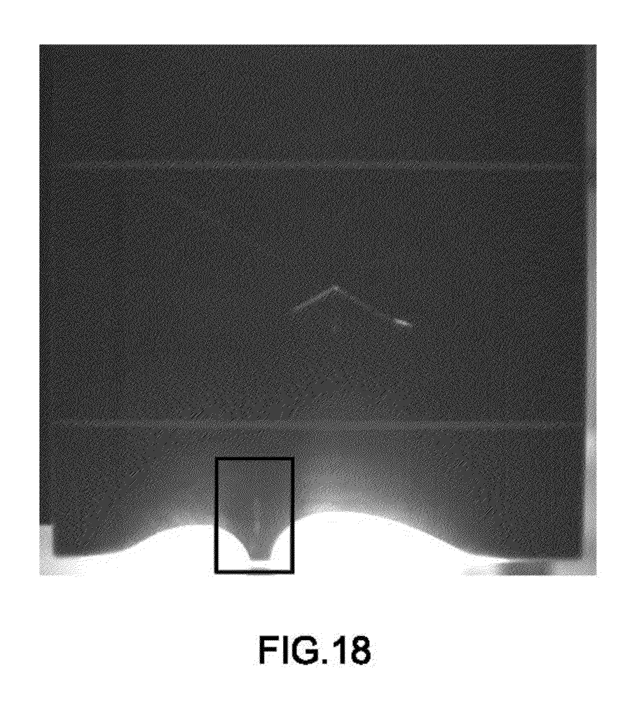

FIGS. 16 and 17 shows another embodiment of the present invention. Comparing to the mentioned embodiment, this embodiment further includes a carrying base 70 and two light shield bars 90. The image capturing module 60 is linear image sensing device. The carrying base 70 includes a bottom frame 71 and a transferring module 72 arranged on the bottom frame 71. The image capturing module 60 is arranged above the substrate 40 to capture the image of a strip-shaped portion 95 of the upper surface 41 of the substrate 40. The light shield bar 90 each are arranged between the light source 50 and the substrate 40 and correspondingly shielding the two ends of the strip-shaped portion 95. Two ends of the strip-shaped portion 95 are covered by the light shield bar 90 and thus unable to receive the light normally emitted from the light sources 50. Only oblique emitted light can reach the ends of the strip-shaped portion 95, this can solve the over-brightness problem at the two ends. The result can be seen from the picture in FIG. 18. It should be mentioned that although two light shield bars 90 are used in this embodiment, in practical use, only one light shield bar 90 arranged at one of the ends of the strip-shaped portion 95 is feasible.

The transferring module 72 can be used for moving the substrate 40 with respect to the image capturing module 60 along the arrow direction in FIG. 17. Consequently, the strip-shaped portion 95 can move along the upper surface 41 and the image capturing module 60 can sequentially capture the images of every parts of the upper surface 41 at a predetermined time interval. Thus, the problem of over brightness at the ends can be solved, and the complete image of the upper surface 41 can obtain.

The mentioned embodiment can be integrated into in-line process equipments, and used to perform substrate inspection before processing, during processing or after processing.

While the invention has been described by means of specific embodiments, numerous modifications and variations could be made thereto by those skilled in the art without departing from the scope and spirit of the invention set forth in the claims.

What is claimed is:

1. A method for inspecting internal defects of substrate, the substrate having an upper surface and a plurality of side surfaces connected with the upper surface, the method comprising:
providing a plurality of light sources on the side surfaces of the substrate, each of the light sources emitting a light beam on a corresponding side surface and into the substrate, wherein the incident angle of the light beam is limited to a first predetermined angle within a range allowing the light beam to transmit in a total internal reflection manner in the substrate, and
providing an image capturing module above the substrate to capture the image of the upper surface of the substrate,
whereby the light sources can be driven one by one to emit light beams to the side surfaces, while one of the light sources emits a light beam to the corresponding side surface, the image capturing module captures the image of a half of the upper surface adjacent to the opposite side surface, and the captured images can be processed into a complete image of the upper surface.

2. The method of claim 1, wherein the light beams are parallel light beams entering the side surfaces.

3. The method of claim 1, wherein the incident angle of the light beam is limited to a second predetermined angle which is a half part of the first predetermined angle away from the image capturing module.

4. An apparatus for inspecting internal defects of substrate, the substrate having an upper surface and a plurality of side surfaces connected with the upper surface, the apparatus comprising:
at least one light source arranged on one of the side surfaces of the substrate, the light source emitting a light beam on a corresponding side surface and into the substrate, wherein the incident angle of the light beam is limited to a first predetermined angle within a range allowing the light beam to transmit in a total internal reflection manner in the substrate;
an image capturing module arranged above the substrate to capture the image of the upper surface of the substrate,
a light shield mask arranged between the image capturing module and the substrate and shielding an edge portion of the upper surface of the substrate.

5. The apparatus of claim 4, wherein the light beams are parallel light beams.

6. The apparatus of claim 4, wherein the incident angle of the light beam is limited to a second predetermined angle which is a half part of the first predetermined angle away from the image capturing module.

7. The apparatus of claim 4, further comprising a plurality of light sources emitting light beams on the other side surfaces and penetrating the substrate.

8. The apparatus of claim 4, wherein the light source is a linear light source parallel to the longitudinal direction of the side surface of the substrate.

9. The apparatus of claim 4, wherein the diameter of the light source is larger than the thickness of the substrate.

10. The apparatus of claim 4, wherein the light shield mask is of ring shape and covers all the edge portions of the upper surface of the substrate.

11. An apparatus for inspecting internal defects of substrate, the substrate having an upper surface and a plurality of side surfaces connected with the upper surface, the apparatus comprising:
at least one light source arranged on one of the side surfaces of the substrate, the light source emitting a light beam on a corresponding side surface and into the substrate, wherein the incident angle of the light beam is limited to a first predetermined angle within a range allowing the light beam to transmit in a total internal reflection manner in the substrate;
an image capturing module arranged above the substrate to capture the image of a strip-shaped portion of the upper surface of the substrate;
a light shield bar arranged between the light source and the substrate and correspondingly shielding an end of the strip-shaped portion; and
a transferring module used for moving the substrate with respect to the image capturing module, whereby the strip-shaped portion can move along the upper surface and the image capturing module can capture the images of every parts of the upper surface.

12. The apparatus of claim 11, wherein the light beams are parallel light beams.

13. The apparatus of claim 11, wherein the incident angle of the light beam is limited to a second predetermined angle which is a half part of the first predetermined angle away from the image capturing module.

14. The apparatus of claim 11, wherein the light source is a linear light source parallel to the longitudinal direction of the side surface of the substrate.

15. The apparatus of claim 11, wherein the diameter of the light source is larger than the thickness of the substrate.
